(19) United States
(12) Patent Application Publication
(10) Pub. No.: US 2021/0355255 A1
(43) Pub. Date: Nov. 18, 2021

(54) RUBBER COMPOSITION

(71) Applicant: SUMITOMO CHEMICAL COMPANY, LIMITED, Tokyo (JP)

(72) Inventors: Yohei FUJII, Ichihara-shi, Chiba (JP); Sadayuki NAKANO, Ichihara-shi, Chiba (JP)

(73) Assignee: SUMITOMO CHEMICAL COMPANY, LIMITED, Tokyo (JP)

(21) Appl. No.: 16/626,309

(22) PCT Filed: Jan. 30, 2019
(86) PCT No.: PCT/JP2019/003237

§ 371 Date: Dec. 23, 2019

(51) Int. Cl. C08F 210/18; C08K 5/526; C08K 5/134

(52) U.S. Cl. CPC C08F 210/18; C08K 5/526; C08F 2500/32; C08F 2500/17; C08K 5/134

(57) ABSTRACT

Provided is a rubber composition containing an ethylene-α-olefin-nonconjugated polyene copolymer rubber and a phenolic antioxidant, in which a content of an ethylene unit in the ethylene-α-olefin-nonconjugated polyene copolymer rubber is from 71% to 99% by mass with respect to a total amount of the ethylene unit, an α-olefin unit, and a nonconjugated polyene unit, a proportion of a cyclohexane insoluble component in the ethylene-α-olefin-nonconjugated polyene copolymer rubber at 25° C. is from 0.2% to 50% by mass with respect to a mass of the ethylene-α-olefin-nonconjugated polyene copolymer rubber, and a content of the phenolic antioxidant is from 0.01 to 0.35 part by mass with respect to 100 parts by mass of a content of the ethylene-α-olefin-nonconjugated polyene copolymer rubber.

### TECHNICAL FIELD

The present invention relates to a rubber composition.

### BACKGROUND ART

Ethylene-α-olefin-nonconjugated polyene copolymer rubber is widely used in applications such as automobile parts and building materials. It is known that an antioxidant is added to rubber compositions containing an ethylene-α-olefin-nonconjugated polyene copolymer rubber in order to prevent deterioration of the rubber compositions due to heat, ultraviolet light, oxygen, or the like (for example, Patent Literature 1).

### CITATION LIST

### Patent Literature

PTL 1: Japanese Unexamined Patent Publication No. 2013-28810

### SUMMARY OF INVENTION

### Technical Problem

The use of rubber compositions containing an antioxidant in applications required to exhibit transparency is limited since the rubber compositions are likely to be colored. In addition, the rubber compositions are deformed and adhere to each other in some cases when pressure and the like are applied thereto. Particularly in the case of a pellet-shaped rubber composition, the pellet-shaped rubber composition forms a bale-shaped lump in some cases as the pellets adhere to each other. For this reason, the rubber composition is required not to adhere to each other.

An object of the present invention is to provide a rubber composition which is hardly colored and exhibits excellent resistance to mutual adhesion.

### Solution to Problem

An aspect of the present invention relates to a rubber composition comprising an ethylene-α-olefin-nonconjugated polyene copolymer rubber and a phenolic antioxidant. In the rubber composition according to the present invention, a content of an ethylene unit in the ethylene-α-olefin-nonconjugated polyene copolymer rubber is from 71% to 99% by mass with respect to a total amount of the ethylene unit, an α-olefin unit, and a nonconjugated polyene unit, a proportion of a cyclohexane insoluble component in the ethylene-α-olefin-nonconjugated polyene copolymer rubber at 25° C. is from 0.2% to 50% by mass with respect to a mass of the ethylene-α-olefin-nonconjugated polyene copolymer rubber, and a content of the phenolic antioxidant is from 0.01 to 0.35 part by mass with respect to 100 parts by mass of a content of the ethylene-α-olefin-nonconjugated polyene copolymer rubber.

The proportion of cyclohexane insoluble component is related to the content of the ethylene unit in the ethylene-α-olefin-nonconjugated polyene copolymer rubber. It can be said that the content of the ethylene unit in the ethylene-α-olefin-nonconjugated polyene copolymer rubber in which the proportion of the cyclohexane insoluble component is within the above range is great to a certain extent. The mutual adhesion of the rubber composition tends to be easily prevented as the rubber composition contains an ethylene-α-olefin-nonconjugated polyene copolymer rubber in which the content of the ethylene unit is great.

It is possible to diminish coloring of the rubber composition by adjusting the amount of the phenolic antioxidant with respect to the ethylene-α-olefin-nonconjugated polyene copolymer rubber to a predetermined range.

### Advantageous Effects of Invention

According to the present invention, it is possible to provide a rubber composition which is hardly colored and exhibits excellent resistance to mutual adhesion.

### DESCRIPTION OF EMBODIMENTS

Hereinafter, embodiments of the present invention will be described. However, the present invention is not limited to the following embodiments.

Rubber Composition

The rubber composition according to an embodiment contains an ethylene-α-olefin-nonconjugated polyene copolymer rubber.

(Ethylene-α-olefin-nonconjugated Polyene Copolymer Rubber)

The ethylene-α-olefin-nonconjugated polyene copolymer rubber according to an embodiment contains an ethylene unit, an α-olefin unit, and a nonconjugated polyene unit as main monomer units. The total content of the ethylene unit, the α-olefin unit, and the nonconjugated polyene unit in the ethylene-α-olefin-nonconjugated polyene copolymer rubber (hereinafter simply referred to as the “copolymer rubber” in some cases) may be 60% by mass or more and 100% by mass or less or 80% by mass or more and 100% by mass or less with respect to the entire mass of the copolymer rubber. In the present specification, the term “monomer name+unit” such as “ethylene unit”, “α-olefin unit”, or “nonconjugated polyene unit” means a monomer unit derived from each monomer.

In the copolymer rubber according to the present embodiment, the proportion of a cyclohexane insoluble component at 25° C. is from 0.2% to 50% by mass with respect to the mass of the ethylene-α-olefin-nonconjugated polyene copolymer rubber. The copolymer rubber which satisfies the proportion of the cyclohexane insoluble component can provide a molded article having a favorable mechanical strength such as a high tensile strength. From the same viewpoint, the proportion of the cyclohexane insoluble component in the copolymer rubber at 25° C. may be from 0.2% to 40% by mass, from 0.2% to 35% by mass, from 0.3% to 30% by mass, or from 0.5% to 15% by mass with respect to the mass of the ethylene-α-olefin-nonconjugated polyene copolymer rubber. The copolymer rubber in which the proportion of the cyclohexane insoluble component is within the above range can be obtained by, for example, adjusting the content of the ethylene unit.

The number of carbon atoms in the α-olefin composing the ethylene-α-olefin-nonconjugated polyene copolymer rubber may be 3 or more and 20 or less. Specific examples of the α-olefin may include straight chain olefins such as propylene, 1-butene, 1-pentene, 1-hexene, 1-heptene, 1-octene, 1-nonene, and 1-decene; branched chain olefins such as 3-methyl-1-butene, 3-methyl-1-pentene, and 4-methyl-1-pentene; and cyclic olefins such as vinylcyclohexane. These may be used singly or in combination. The α-olefin may be propylene and/or 1-butene or may be propylene.

The nonconjugated polyene may be a nonconjugated polyene having 3 or more and 20 or less carbon atoms. The nonconjugated polyene may be a chain nonconjugated diene, a cyclic nonconjugated diene, a triene, or any combination thereof.

Examples of the chain nonconjugated diene may include 1,4-hexadiene, 1,6-octadiene, 2-methyl-1,5-hexadiene, 6-methyl-1,5-heptadiene, and 7-methyl-1,6-octadiene.

Examples of the cyclic nonconjugated diene may include cyclohexadiene, dicyclopentadiene, 5-vinylnorbornene, 5-ethylidene-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(6-heptenyl)-2-norbornene, 5-(7-octenyl)-2-norbornene, 5-methylene-2-norbornene, and 6-chloromethyl-5-isopropenyl-2-norbornene.

Examples of the triene may include 4-ethylidene-8-methyl-1,7-nonadiene, 5,9,13-trimethyl-1,4,8,12-tetradecadiene, 4-ethylidene-12-methyl-1,11-pentadecadiene, 2,3-diisopropylidene-5-norbornene, 2-ethylidene-3-isopropylidene-5-norbornene, 2-propenyl-2,2-norbornadiene, 1,3,7-octatriene, 6,10-dimethyl-1,5,9-undecatriene, 5,9-dimethyl-1,4,8-decatriene, 13-ethyl-9-methyl-1,9,12-pentadecatriene, 5,9,8,14,16-pentamethyl-1,7,14-hexadecatriene, and 1,4,9-decatriene.

The nonconjugated polyene may be 5-ethylidene-2-norbornene, dicyclopentadiene, 5-vinylnorbornene, or a combination of two or more kinds selected from these. The nonconjugated polyene may be a combination of 5-ethylidene-2-norbornene and dicyclopentadiene, or only 5-ethylidene-2-norbornene.

The content of the ethylene unit is from 71% to 99% by mass with respect to the total amount of the ethylene unit, the α-olefin unit, and the conjugated polyene unit. It is easy to suppress mutual adhesion of the rubber composition when the content of the ethylene unit is relatively high as described above. From the same viewpoint, the content of the ethylene unit may be from 72% to 98% by mass, from 73% to 95% by mass, or from 73% to 90% by mass with respect to the total amount of the ethylene unit, the propylene unit, and the nonconjugated polyene unit.

Specific examples of the ethylene-α-olefin-nonconjugated polyene copolymer rubber may include ethylene-propylene-5-ethylidene-2-norbornene copolymer rubber, ethylene-propylene-dicyclopentadiene copolymer rubber, ethylenepropylene-1,4-hexadiene copolymer rubber, ethylene-propylene-1,6-octadiene copolymer rubber, ethylene-propylene-2-methyl-1,5-hexadiene copolymer rubber, ethylene-propylene-6-methyl-1,5-heptadiene copolymer rubber, ethylene-propylene-7-methyl-1,6-octadiene copolymer rubber, ethylene-propylene-cyclohexadiene copolymer rubber, ethylene-propylene-5-vinylnorbornene copolymer rubber, ethylene-propylene-5-(2-propenyl)-2-norbornene copolymer rubber, ethylene-propylene-5-(3-butenyl)-2-norbornene copolymer rubber, ethylene-propylene-5-(4-pentenyl)-2-norbornene copolymer rubber, ethylene-propylene-5-(5-hexenyl)-2-norbornene copolymer rubber, ethylene-propylene-5-(6-heptenyl)-2-norbornene copolymer rubber, ethylene-propylene-5-(7-octenyl)-2-norbornene copolymer rubber, ethylene-propylene-5-methylene-2-norbornene copolymer rubber, ethylene-propylene-4-ethylidene-8-methyl-1,7-nonadiene copolymer rubber, ethylene-propylene-5,9,13-trimethyl-1,4,8,12-tetradecadiene copolymer rubber, ethylene-propylene-4-ethylidene-12-methyl-1,11-pentadecadiene copolymer rubber, ethylene-propylene-6-chloromethyl-5-isopropenyl-2-norbornene copolymer rubber, ethylene-propylene-2,3-diisopropylidene-5-norbornene copolymer rubber, ethylene-propylene-2-ethylidene-3-isopropylidene-5-norbornene copolymer rubber, ethylene-propylene-2-propenyl-2,2-norbornadiene copolymer rubber, ethylene-propylene-1,3,7-octatriene copolymer rubber, ethylene-propylene-6,10-dimethyl-1,5,9-undecatriene copolymer rubber, ethylene-propylene-5,9-dimethyl-1,4,8-decatriene copolymer rubber, ethylene-propylene-13-ethyl-9-methyl-1,9,12-pentadecatriene copolymer rubber, ethylene-propylene-5,9,8,14,16-pentamethyl-1,7,14-hexadecatriene copolymer rubber, and ethylene-propylene-1,4,9-decatriene copolymer rubber. Two or more kinds of copolymer rubbers selected from these may be combined.

The ethylene-α-olefin-nonconjugated polyene copolymer rubber may be ethylene-propylene-5-ethylidene-2-norbornene copolymer rubber, ethylene-propylene-dicyclopentadiene copolymer rubber, ethylene-propylene-5-vinylnorbornene copolymer rubber, or any combination thereof, or may be ethylene-propylene-5-ethylidene-2-norbornene copolymer rubber.

In a case in which two or more kinds of ethylene-α-olefin-nonconjugated polyene copolymer rubbers are combined, the content of the ethylene unit described above, the content of the α-olefin unit, and the iodine value are values in the sum of the combination of two or more kinds.

Process oil such as paraffin-based oil and naphthene-based oil may be added to the ethylene-α-olefin-nonconjugated polyene copolymer rubber to form an oil extended rubber.

The intrinsic viscosity of the copolymer rubber according to the present embodiment measured in tetralin at 135° C. may be from 0.5 to 5.0 dL/g. The advantageous effect of further improving the processability in kneading can be obtained when the intrinsic viscosity is within this range. When the copolymer rubber exhibiting excellent processability is used, for example, a kneaded material which is uniformly kneaded can be more easily obtained. From the same viewpoint, the intrinsic viscosity of the copolymer rubber may be from 0.9 to 3.0 dL/g, from 0.9 to 2.0 dL/g, or from 1.0 to 1.5 dL/g.

The molecular weight distribution (Mw/Mn) of the ethylene-α-olefin-nonconjugated polyene copolymer rubber may be from 1.5 to 5.0. The advantageous effect of making processability in kneading consistent with mechanical properties at higher levels can be obtained when the molecular weight distribution of the ethylene-α-olefin-nonconjugated polyene copolymer rubber is within this range. From the same viewpoint, the molecular weight distribution of the ethylene-α-olefin-nonconjugated polyene copolymer rubber may be from 1.6 to 4.0, from 1.8 to 3.5, or from 2.0 to 3.0.

In the present specification, the molecular weight distribution is a ratio (Mw/Mn) calculated from the weight average molecular weight (Mw) and number average molecular weight (Mn) in terms of polystyrene measured by gel permeation chromatography (GPC method).

The measurement conditions in the GPC method for measuring Mw and Mn are, for example, as follows.
GPC apparatus: HLC-8121 GPC/HT (trade name) manufactured by Tosoh Corporation
Column: TSKgel GMHHR-H(S) HT (trade name) manufactured by Tosoh Corporation
Standard substance for molecular weight: polystyrene having molecular weight of 500 or more and 20,000,000 or less
Flow rate of eluting solvent: 1.0 mL/min
Concentration of sample: 1 mg/mL
Measuring temperature: 140° C.
Eluting solvent: orthodichlorobenzene
Injection volume: 500 μL
Detector: differential refractometer

The glass transition temperature of the ethylene-α-olefin-nonconjugated polyene copolymer rubber may be from −55° C. to −30° C. A molded article having superior physical properties at a low temperature is likely to be obtained when the glass transition temperature of the copolymer is within this range. From the same viewpoint, the glass transition temperature of the ethylene-α-olefin-nonconjugated polyene copolymer rubber may be from −55° C. to −35° C., from −50° C. to −35° C., or from −45° C. to −35° C. The glass transition temperature herein is a temperature at the midpoint of the glass transition portion in the thermogram obtained by differential scanning calorimetry at a rate of temperature increase of 5°/min.

The content of the ethylene-α-olefin-nonconjugated polyene copolymer rubber in the rubber composition may be from 10% to 90% by mass, from 20% to 90% by mass, from 10% to 80% by mass, or from 20% to 80% by mass or less.

(Method of Producing ethylene-α-olefin-nonconjugated Polyene Copolymer Rubber)

The ethylene-α-olefin-nonconjugated polyene copolymer rubber according to the present embodiment can be obtained, for example, by a method including a step of copolymerizing a monomer mixture containing ethylene, an α-olefin, and a nonconjugated polyene in the presence of a catalyst such as a so-called Ziegler-Natta catalyst or a metallocene catalyst.

As the catalyst for the copolymerization, it is possible to use a catalyst obtained by bringing a vanadium compound represented by the following Formula (1) into contact with an organoaluminum compound represented by the following Formula (2).

VO(OR)ₕX′₃₋ₕ (1)

In the formula, R represents a straight chain hydrocarbon group having 1 or more and 8 or less carbon atoms, X′ represents a halogen atom, and h represents a number satisfying 0<h<=3.

R″ⱼAlX″₃₋ⱼ (2)

In the formula, R″ represents a hydrocarbon group, X″ represents a halogen atom, and j represents a number satisfying 0<j<=3.

R″ in Formula (2) may be an alkyl group having from 1 to 10 carbon atoms. Examples of the alkyl group having from 1 to 10 carbon atoms may include a methyl group, an ethyl group, a n-propyl group, an iso-propyl group, a n-butyl group, an iso-butyl group, a pentyl group, and a hexyl group. Examples of X″ may include a fluorine atom and a chlorine atom, j may be a number satisfying 0<j<=2.

Specific examples of the organoaluminum compound represented by Formula (2) may include (C₂H₅)₂AlCl, (n-C₄H₉)₂AlCl, (iso-C₄H₉)₂AlCl, (n-C₆H₁₃)₂AlCl, (C₂H₅)_{1.5}AlCl_{1.5}, (n-C₄H₉)_{1.5}AlCl_{1.5}, (iso-C₄H₉)_{1.5}AlCl_{1.5}, (n-C₆H₁₃)_{1.5}AlCl_{1.5}, C₂H₅AlCl₂, (n-C₄H₉) AlCl₂, (iso-C₄H₉)AlCl₂, and (n-C₆H₁₃)AlCl₂. The organoaluminum compound may be (C₂H₅)₂AlCl, (C₂H₅)_{1.5}AlCl_{1.5}, or C₂H₅AlCl₂. These may be used singly or in combination.

The molar ratio (mole of organoaluminum compound/mole of vanadium compound) of the used amount of the organoaluminum compound represented by Formula (2) to the used amount of the vanadium compound represented by Formula (1) may be from 0.1 to 50, from 1 to 30 or less, from 2 to 15, or from 3 to 10. The intrinsic viscosity, Mw/Mn and the like of the ethylene-α-olefin-nonconjugated polyene copolymer rubber can be adjusted by adjusting the molar ratio. For example, the intrinsic viscosity of the ethylene-α-olefin-nonconjugated polyene copolymer rubber tends to increase and Mw/Mn tends to decrease when the molar ratio is great.

The polymerization reaction may be conducted, for example, in one polymerization tank or in two polymerization tanks connected in series by two stages. It is possible to supply a monomer, a catalyst, and, if necessary, other components to the polymerization tank and to polymerize the monomer in the polymerization tank.

The polymerization reaction is usually conducted in a solvent. Examples of the solvent to be used in the polymerization may include inert solvents such as aliphatic hydrocarbons such as propane, butane, isobutane, pentane, hexane, heptane, and octane; and alicyclic hydrocarbons such as cyclopentane and cyclohexane. These may be used singly or in combination. The solvent may contain an aliphatic hydrocarbon.

The polymerization temperature may be from 0° C. to 200° C., from 20° C. to 150° C., or from 30° C. to 120° C. The polymerization pressure may be from 0.1 to 10 MPa, from 0.1 to 5 MPa, or from 0.1 to 3 MPa. It is possible to adjust Mw/Mn and the like of the ethylene-α-olefin-nonconjugated polyene copolymer rubber by adjusting the polymerization temperature. For example, Mw/Mn tends to decrease when the polymerization temperature is low.

At the time of polymerization, hydrogen may be supplied into the polymerization tank as a molecular weight modifier if necessary. The amount of hydrogen to be supplied into the polymerization tank may be from 0.001 to 0.1 NL, from 0.005 to 0.05 NL, or from 0.01 to 0.04 NL per 1 kg of the solvent to be supplied into the polymerization tank. It is possible to adjust Mw/Mn, intrinsic viscosity and the like of the ethylene-α-olefin-nonconjugated polyene copolymer rubber by adjusting the amount of hydrogen supplied. For example, Mw/Mn tends to decrease when the amount of hydrogen supplied is great. The intrinsic viscosity tends to increase when the amount of hydrogen supplied is small.

The amount of the vanadium compound to be supplied into the polymerization tank may be from 0.002 to 0.2 part by mass or from 0.003 to 0.1 part by mass per 100 parts by mass of the solvent to be supplied into the polymerization tank. There is a tendency that the intrinsic viscosity can be increased when the quantitative ratio of the vanadium compound to the solvent is great.

(Phenolic Antioxidant)

The content of the phenolic antioxidant in the rubber composition according to the present embodiment is from 0.01 to 0.35 part by mass with respect to 100 parts by mass of the content of the ethylene-α-olefin-nonconjugated polyene copolymer rubber from the viewpoint of diminishing coloring. From the same viewpoint, the content of the phenolic antioxidant is may be from 0.05 to 0.30 part by mass, from 0.08 to 0.26 part by mass, or from 0.1 to 0.24 part by mass. One kind of phenolic antioxidant may be used singly or two or more kinds thereof may be used in combination.

The phenolic antioxidant according to the present embodiment is not particularly limited. As the phenolic antioxidant according to an embodiment, a phenolic antioxidant represented by the following Formula (I) or (II) may be used.

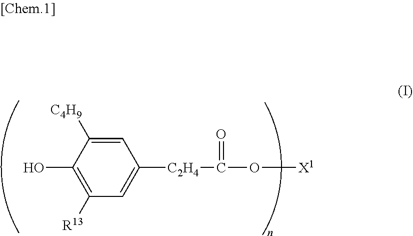

In Formula (I), R¹³ represents an alkyl group having from 1 to 8 carbon atoms. Examples of the alkyl group having from 1 to 8 carbon atoms may include linear, branched, or cyclic alkyl groups such as a methyl group, an ethyl group, a n-propyl group, an iso-propyl group, a n-butyl group, an i-butyl group, a sec-butyl group, a t-butyl group, a t-pentyl group, an i-octyl group, a t-octyl group, a 2-ethylhexyl group, a cyclopentyl group, a cyclohexyl group, a cycloheptyl group, a cyclooctyl group, and a 1-methylcyclohexyl group. R¹³ may be a methyl group or a t-butyl group. C₄H₉ may be a t-butyl group.

In Formula (I), X¹ represents an n-valent alcohol residue which has from 1 to 18 carbon atoms and may contain a hetero atom and/or a cyclic group, and n is an integer from 1 to 4. An alcohol residue refers to the moiety of an alcohol excluding OH. Examples of the hetero atom may include an oxygen atom, a nitrogen atom, and a sulfur atom. Examples of the cyclic group may include a 2,4,6,8,10-tetraoxaspiro[5.5]undecane ring, a benzene ring, and a cyclohexane ring.

Examples of X¹ may include residues of monohydric alcohols such as methyl alcohol, ethyl alcohol, 2-ethyl-hexyl alcohol, octyl alcohol, and octadecyl alcohol; residues of dihydric alcohols such as ethylene glycol, triethylene glycol, 2,2′-thiodiethanol, and 3,9-bis-(1,1-dimethyl-2-hydroxyethyl)-2,4,8-tetraspiro[5.5]undecane; residues of trihydric alcohols such as glycerin and N,N′,N″-tris(hydroxyethyl) isocyanurate; and residues of tetrahydric alcohols such as pentaerythritol.

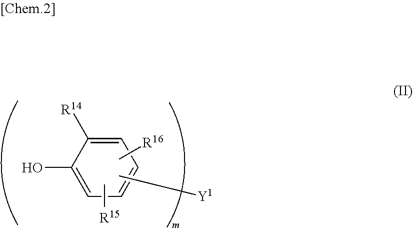

In Formula (II), R¹⁴ represents an alkyl group having from 1 to 8 carbon atoms. Examples of the alkyl group having from 1 to 8 carbon atoms in R¹⁴ may include the linear, branched, or cyclic alkyl groups described above. R¹⁴ may be a methyl group or a t-butyl group.

In Formula (II), R¹⁵ and R¹⁶ each independently represent a hydrogen atom or an alkyl group which has from 1 to 18 carbon atoms and may contain a hetero atom. Examples of the alkyl group which has from 1 to 18 carbon atoms and may contain a hetero atom may include the linear, branched, or cyclic alkyl groups described above, an octylthiomethylene group, a 2-ethylhexylthiomethylene group, and a N,N′-dimethylaminomethylene group.

In Formula (II), Y¹ represents an m-valent group, and m is an integer from 1 to 3. Y¹ represents a hydrogen atom or an alkyl group which has from 1 to 18 carbon atoms and may contain a hetero atom in a case in which m is 1, Y¹ represents a sulfur atom, an oxygen atom, or an alkylidene group having from 1 to 4 carbon atoms in a case in which m is 2, and Y¹ represents an isocyanuric acid-N,N′,N″-trimethylene group or a 1,3,5-trimethylbenzene-2,4,6-trimethylene group in a case in which m is 3. Examples of the alkyl group which has from 1 to 18 carbon atoms and may contain a hetero atom may include the linear, branched, or cyclic alkyl groups described above, an octylthiomethylene group, a 2-ethylhexylthiomethylene group, and a N,N′-dimethylaminomethylene group. Examples of the alkylidene group having from 1 to 4 carbon atoms may include a methylene group, an ethylidene group, a propylidene group, and a butylidene group. Y¹ may be a hydrogen atom, a methylene group, a butylidene group, a sulfur atom, or a 1,3,5-trimethylbenzene-2,4,6-trimethylene group.

Examples of the phenolic antioxidant represented by Formula (I) may include n-octadecyl-3-(3,5-di-t-butyl-4-hydroxyphenyl) propionate, 3,9-bis(2-(3-(3-t-butyl-4-hydroxy-5-methylphenyl)-propionyloxy)-1,1-dimethylethyl)-2,4,8,10-tetraoxaspiro[5.5]undecane, triethylene glycol bis(3-(3-t-butyl-5-methyl-4-hydroxyphenyl) propionate, tetrakis(methylene(3,5-di-t-butyl-4-hydroxyphenyl) propionate)methane, and tris[2-(3′,5′-)-t-butyl-4′-hydroxyhydro-cinnamoyloxyl)ethyl]isocyanurate.

Examples of the phenolic antioxidant represented by Formula (II) may include 2,6-di-t-butyl-4-methylphenol, 2,6-di-t-butyl-4-ethylphenol, 2,4,6-tri-t-butylphenol, 2,6-di-t-butyl-4-hydroxymethylphenol, 2,2′-methylenebis(4-ethyl-6-t-butylphenol), 2,2′-methylenebis(6-cyclohexyl-4-methylphenol), 2,2′-methylenebis(4,6-di-t-butylphenol), 2,2′-ethylidenebis(4,6-di-t-butylphenol), 4,4′-methylenebis(2,6-di-t-butylphenol), 4,4′-butylidenebis(3-methyl-6-t-butylphenol), 2,2′-methylenebis(4-methyl-6-t-butylphenol), 1,3,5-trimethyl-2,4,6-tris(3,5-di-t-butyl-4-hydroxybenzyl)benzene, 4,4′-thiobis(3-methyl-6-t-butylphenol), 1,3,5-tris(4-t-butyl-3-hydroxy-2,6-dimethyl-benzyl) isocyanate, and 1,3,5-tris(3,5-di-t-butyl-4-hydroxy-benzyl) isocyanate.

As the phenolic antioxidant according to the present embodiment, a phenolic antioxidant represented by the following Formula (III) may be used.

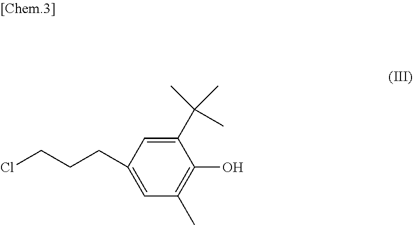 [SMILES: Cc1cc(CCCCl)cc(C(C)(C)C)c1O]

As the phenolic antioxidant according to the present embodiment, a phenolic antioxidant represented by the following Formula (IV) may be used.

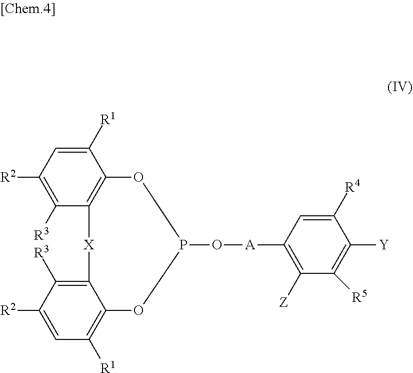

In Formula (IV), R¹, R², R⁴, and R⁵ each independently represent a hydrogen atom, an alkyl group having from 1 to 12 carbon atoms, an aralkyl group having from 7 to 12 carbon atoms, or a phenyl group.

Examples of the alkyl group having from 1 to 12 carbon atoms may include a methyl group, an ethyl group, a n-propyl group, an i-propyl group, a n-butyl group, an i-butyl group, a sec-butyl group, a t-butyl group, a t-pentyl group, an i-octyl group, a t-octyl group, a 2-ethylhexyl group, a cyclopentyl group, a cyclohexyl group, a cycloheptyl group, a cyclooctyl group, a 1-methylcyclopentyl group, a 1-methylcyclohexyl group, and a 1-methyl-4-i-propylcyclohexyl group. Examples of the aralkyl group having from 7 to 12 carbon atoms may include a benzyl group, an α-methylbenzyl group, and an α,α-dimethylbenzyl group.

R¹ and R⁴ may each independently be a t-alkyl group such as a t-butyl group, a t-pentyl group or a t-octyl group, a cyclohexyl group, or a 1-methylcyclohexyl group. R² may be a methyl group, an ethyl group, a n-propyl group, an i-propyl group, a n-butyl group, an i-butyl group, a sec-butyl group, a t-butyl group, or a t-pentyl group, or may be a methyl group, a t-butyl group, or a t-pentyl group. R⁵ may be a hydrogen atom, a methyl group, an ethyl group, a n-propyl group, an i-propyl group, a n-butyl group, an i-butyl group, a sec-butyl group, a t-butyl group, or a t-pentyl group.

In Formula (IV), R³ represents a hydrogen atom or an alkyl group having from 1 to 8 carbon atoms. Examples of the alkyl group having from 1 to 8 carbon atom may include the alkyl groups described above. R³ may be a hydrogen atom or an alkyl group having from 1 to 5 carbon atoms, or may be a hydrogen atom or a methyl group.

In Formula (IV), X represents a single bond, a sulfur atom, or a group represented by “—CH(R⁶)—”, where R⁶ represents a hydrogen atom or an alkyl group having from 1 to 8 carbon atoms. Examples of the alkyl group having from 1 to 8 carbon atoms may include the alkyl groups described above. X may be a methylene group substituted with an alkyl group such as a methyl group, an ethyl group, a n-propyl group, an i-propyl group, a n-butyl group, an i-butyl group or a t-butyl group, or a single bond, and X is preferably a single bond.

In Formula (IV), A represents an alkylene group having from 1 to 8 carbon atoms or a group represented by “*—C(═O)—R⁷—”. R⁷ represents a single bond or an alkylene group having from 1 to 8 carbon atoms, and “*” denotes the position at which the group is bonded to an oxygen atom. Examples of the alkylene group having from 1 to 8 carbon atoms may include a methylene group, an ethylene group, a propylene group, a butylene group, a pentamethylene group, a hexamethylene group, an octamethylene group, and a 2,2-dimethyl-1,3-propylene group. R⁷ may be a single bond or an ethylene group. A may be a propylene group.

In Formula (IV), either of Y or Z represents a hydroxyl group, an alkoxy group having from 1 to 8 carbon atoms, or an aralkyloxy group having from 7 to 12 carbon atoms, and the other represents a hydrogen atom or an alkyl group having from 1 to 8 carbon atoms. Examples of the alkoxy group having from 1 to 8 carbon atoms may include a methoxy group, an ethoxy group, a propoxy group, and a butoxy group. Examples of the alkyl group having from 1 to 8 carbon atoms may include the alkyl groups described above. Examples of the aralkyloxy group having from 7 to 12 carbon atoms may include a benzyloxy group, an α-methylbenzyloxy group, and an α,α-dimethylbenzyloxy group.

Examples of the phenolic antioxidant represented by Formula (IV) may include 2,4,8,10-tetra-t-butyl-6-[3-(3-methyl-4-hydroxy-5-t-butylphenyl)propoxy]dibenzo[d,f][1,3,2]dioxaphosphepine, 6-[3-(3,5-di-t-butyl-4-hydroxyphenyl)propoxy]-2,4,8,10-tetra-t-butyldibenzo[d,f][1,3,2]dioxaphosphepine, 6-[3-(3,5-di-t-butyl-4-hydroxyphenyl(propoxy]-4,8-di-t-butyl-2,10-dimethyl-12H-dibenzo[d,g][1,3,2]dioxaphosphocine, and 6-[3-(3,5-di-t-butyl-4-hydroxyphenyl)propionyloxy]-4,8-di-t-butyl-2,10-dimethyl-12H-dibenzo[d,g][1,3,2]dioxaphosphocine.

As the phenolic antioxidant, commercial available products such as Irganox 1010, 1035, 1076, 1135, and 1330 (manufactured by BASF SE) and SUMILIZER (registered trademark) GM and SUMILIZER (registered trademark) GP (manufactured by SUMITOMO CHEMICAL CO., LTD.) may be used.

A phosphorus-based antioxidant may be added to the rubber composition according to the present embodiment together with the phenolic antioxidant. It is possible to diminish coloring of the rubber composition by concurrently using a phosphorus-based antioxidant. The content of the phosphorus-based antioxidant in the rubber composition may be 0.20 part by mass or less, 0.15 part by mass or less, or 0.12 part by mass or less with respect to 100 parts by mass of the content of the ethylene-α-olefin-nonconjugated polyene copolymer rubber. The lower limit value of the content of the phosphorus-based antioxidant in the rubber composition may be, for example, 0.005 part by mass or more.

Examples of the phosphorus-based antioxidant may include, but are not limited to, trioctyl phosphite, trilauryl phosphite, tridecyl phosphite, tris(nonylphenyl)phosphite, distearyl pentaerythritol diphosphite, tetra(tridecyl)-1,1,3-tris(2-methyl-5-tert-butyl-4-hydroxyphenyl)butane diphosphite, and tris(2,4-di-tert-butylphenyl) phosphite.

As the phosphorus-based antioxidant, for example, a commercially available product such as Irgafos 168 (manufactured by BASF SE) may be used.

(Other Components)

The rubber composition of the present embodiment may further contain at least one kind of other component selected from the group consisting of a rubber component other than the ethylene-α-olefin-nonconjugated polyene copolymer rubber, a reinforcing agent, a softening agent, a vulcanizing agent, a vulcanization accelerator, a vulcanization aid, a processing aid, a rubber antioxidant, and a silane coupling agent in addition to the ethylene-α-olefin-nonconjugated polyene copolymer rubber and the phenolic antioxidant. The rubber composition may further contain a reinforcing agent, a vulcanizing agent or both of these. The rubber composition may contain a vulcanizing agent and a vulcanization accelerator, a vulcanization aid, or both of these.

The rubber components other than the ethylene-α-olefin-nonconjugated polyene copolymer rubber, which can be contained in the rubber composition may be, for example, at least one kind selected from natural rubber, isoprene rubber, butadiene rubber, styrene butadiene rubber, or butyl rubber.

The content of the other rubber components in the rubber composition may be from 10 to 40 parts by mass or from 15 to 30 parts by mass with respect to 100 parts by mass of the content of the ethylene-α-olefin-nonconjugated polyene copolymer rubber.

The reinforcing agent is an additive for improving the mechanical properties of a vulcanizate of a rubber composition as described in Handbook of Compounding Ingredients for Rubber and Plastics (published by Rubber Digest Co., Ltd., on Apr. 20, 1981). The reinforcing agent may contain at least one kind selected from, for example, carbon black, silica produced by a dry method, silica produced by a wet method, synthetic silicate-based silica, colloidal silica, basic magnesium carbonate, activated calcium carbonate, heavy calcium carbonate, light calcium carbonate, mica, magnesium silicate, aluminum silicate, lignin, aluminum hydroxide, and magnesium hydroxide.

The content of the reinforcing agent in the rubber composition may be from 20 to 250 parts by mass, from 30 to 200 parts by mass, or from 40 to 180 parts by mass with respect to 100 parts by mass of the content of the ethylene-α-olefin-nonconjugated polyene copolymer rubber.

The softening agent may contain at least one kind selected, for example, from paraffin-based oil, naphthene-based oil, petroleum asphalt, petroleum jelly, coal tar pitch, castor oil, linseed oil, factice, dense wax, or ricinoleic acid. The softening agent may be process oil or lubricating oil.

The content of the softening agent in the rubber composition may be from 5 to 250 parts by mass, from 5 to 150 parts by mass, or from 5 to 80 parts by mass with respect to 100 parts by mass of the content of the ethylene-α-olefin-nonconjugated polyene copolymer rubber.

The vulcanizing agent is a component for crosslinking the ethylene-α-olefin-nonconjugated polyene copolymer rubber to form a vulcanizate. The vulcanizing agent may be sulfur, a sulfur-based compound, an organic peroxide, or any combination thereof.

The sulfur may be, for example, powdered sulfur, precipitated sulfur, colloidal sulfur, surface-treated sulfur, or insoluble sulfur.

The total content of sulfur and sulfur-based compound in the rubber composition may be from 0.01 to 10 parts by mass or from 0.1 to 5 parts by mass with respect to 100 parts by mass of the content of the ethylene-α-olefin-nonconjugated polyene copolymer rubber.

Examples of the organic peroxide may include dicumyl peroxide, 2,5-dimethyl-2,5-di(t-butylperoxy)hexane, 2,5-dimethyl-2,5-di(benzoylperoxy)hexane, 2,5-dimethyl-2,5-di(t-butylperoxy)hexyne-3, di-t-butyl peroxide, di-t-butyl peroxide-3,3,5-trimethylcyclohexane, and t-butyl hydroperoxide. The organic peroxide may be dicumyl peroxide, di-t-butyl peroxide, di-t-butyl peroxide-3,3,5-trimethylcyclohexane, or any combination thereof, or may be dicumyl peroxide.

The content of the organic peroxide in the rubber composition may be from 0.1 to 15 parts by mass or from 1 to 8 parts by mass with respect to 100 parts by mass of the content of the ethylene-α-olefin-nonconjugated polyene copolymer rubber.

The vulcanization accelerator is a component for accelerating the crosslinking reaction by the vulcanizing agent and thus shortening the vulcanization time. The vulcanization accelerator may contain at least one kind of compound selected from, for example, tetramethylthiuram monosulfide, tetramethylthiuram disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazole sulfenamide, 2-mercaptobenzothiazole, 2-(2,4-dinitrophenyl)mercaptobenzothiazole, 2-(2,6-diethyl-4-morpholinothio)benzothiazole, dibenzothiazyl disulfide, diphenyl guanidine, triphenyl guanidine, di-o-tolylguanidine, orthotolyl-bi-guanide, diphenyl guanidine-phthalate, n-butyraldehyde aniline, hexamethylenetetramine, acetaldehyde ammonia, 2-mercaptoimidazoline, thiocarbanilide, diethyl thiourea, dibutyl thiourea, trimethyl thiourea, di-o-tolylthiourea, zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthate, or ethylene thiourea.

The content of the vulcanization accelerator in the rubber composition may be from 0.05 to 20 parts by mass or from 0.1 to 8 parts by mass with respect to 100 parts by mass of the content of the ethylene-α-olefin-nonconjugated polyene copolymer rubber.

The vulcanization aid is a component used in combination with the vulcanization accelerator or singly for accelerating the crosslinking reaction by the vulcanizing agent and thus increasing the crosslinking density of vulcanizate. The vulcanization aid may contain at least one kind of compound selected from, for example, triallyl isocyanurate, N,N′-m-phenylene bismaleimide, methacrylic acid, methyl methacrylate, ethyl methacrylate, propyl methacrylate, isopropyl methacrylate, n-butyl methacrylate, butyl methacrylate, sec-butyl methacrylate, t-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethylene glycol monomethacrylate, polypropylene glycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butanediol diacrylate, ethylene glycol dimethacrylate, 1,3-butylene glycol dimethacrylate, neopentyl glycol dimethacrylate, 1,6-hexanediol dimethacrylate, diethylene glycol dimethacrylate, triethylene glycol dimethacrylate, polyethylene glycol dimethacrylate, dipropylene glycol dimethacrylate, polypropylene glycol dimethacrylate, trimethylolethane trimethacrylate, trimethylolpropane trimethacrylate, allyl glycidyl ether, N-methylolmethacrylamide, 2,2-bis(4-methacryloxypolyethoxyphenyl)propane, aluminum methacrylate, zinc methacrylate, calcium methacrylate, magnesium methacrylate, 3-chloro-2-hydroxypropyl methacrylate, zinc oxide, or magnesium oxide.

The content of the vulcanization aid in the rubber composition may be from 0.05 to 15 parts by mass or from 0.1 to 8 parts by mass with respect to 100 parts by mass of the content of the ethylene-α-olefin-nonconjugated polyene copolymer rubber.

The processing aid contains, for example, a fatty acid, a metal salt of a fatty acid, an ester of a fatty acid, a glycol, or any combination thereof. Examples of the fatty acid may include oleic acid, palmitic acid, and stearic acid. Examples of the metal salt of a fatty acid may include zinc laurate, zinc stearate, barium stearate, and calcium stearate. Examples of the glycol may include ethylene glycol and polyethylene glycol.

The content of the processing aid in the rubber composition may be from 0.2 to 10 parts by mass or from 0.3 to 8 parts by mass with respect to 100 parts by mass of the content of the ethylene-α-olefin-nonconjugated polyene copolymer rubber.

The silane coupling agent may be at least one kind selected from, for example, a silane-based silane coupling agent, a vinyl-based silane coupling agent, a methacrylic silane coupling agent, an epoxy-based silane coupling agent, a mercapto-based silane coupling agent, a sulfur-based silane coupling agent, an amino-based silane coupling agent, a ureido-based silane coupling agent, or an isocyanate-based silane coupling agent.

The content of the silane coupling agent in the rubber composition may be from 0.1 to 10 parts by mass or from 0.5 to 8 parts by mass with respect to 100 parts by mass of the content of the ethylene-α-olefin-nonconjugated polyene copolymer rubber.

The rubber antioxidant may contain an amine-based rubber antioxidant, a sulfur-based rubber antioxidant, or both of these. The content of the rubber antioxidant in the rubber composition may be from 0.1 to 40 parts by mass or from 0.1 to 30 parts by mass with respect to 100 parts by mass of the content of the ethylene-α-olefin-nonconjugated polyene copolymer rubber.

Examples of the amine-based rubber antioxidant may include naphthylamine-based rubber antioxidants such as phenyl-α-naphthylamine and phenyl-β-naphthylamine; diphenylamine-based rubber antioxidants such as p-(p-toluenesulfonylamide)diphenylamine, 4,4′-bis(α,α-dimethylbenzyl)diphenylamine, alkylated diphenylamine (for example, octylated diphenylamine), dioctylated diphenylamine (for example, 4,4′-dioctyldiphenylamine), a reaction product of diphenylamine with acetone at a high temperature, a reaction product of diphenylamine with acetone at a low temperature, a reaction product of diphenylamine with aniline and acetone at a low temperature, and a reaction product of diphenylamine with diisobutylene; and p-phenylenediamine-based rubber antioxidants such as N,N′-diphenyl-p-phenylenediamine, N-isopropyl-N′-phenyl-p-phenylenediamine, N,N′-di-2-naphthyl-p-phenylenediamine, N-cyclohexyl-N′-phenyl-p-phenylenediamine, N-phenyl-N′-(3-methacryloyloxy-2-hydroxypropyl)-p-phenylenediamine, N,N′-bis(1-methylheptyl)-p-phenylenediamine, N,N′-bis(1,4-dimethylpentyl)-p-phenylenediamine, N,N′-bis(1-ethyl-3-methylpentyl)-p-phenylenediamine, N-(1,3-dimethylbutyl)-N′-phenyl-p-phenylenediamine, N-hexyl-N′-phenyl-p-phenylenediamine, and N-octyl-N′-phenyl-p-phenylenediamine. These may be used singly or in combination.

The amine-based rubber antioxidant may be a diphenylamine-based rubber antioxidant. The diphenylamine-based rubber antioxidant may be 4,4′-bis(α,α-dimethylbenzyl)diphenylamine, N,N′-diphenyl-p-phenylenediamine, N,N′-di-2-naphthyl-p-phenylenediamine, or any combination thereof.

Examples of the sulfur-based rubber antioxidant may include imidazole-based rubber antioxidants such as 2-mercaptobenzimidazole, a zinc salt of 2-mercaptobenzimidazole, 2-mercaptomethylbenzimidazole, zinc salt of 2-mercaptomethylbenzimidazole, and a zinc salt of 2-mercaptomethylimidazole; and aliphatic thioether-based rubber antioxidants such as dimyristyl thiodipropionate, dilauryl thiodipropionate, distearyl thiodipropionate, ditridecyl thiodipropionate, and pentaerythritol-tetrakis(β-lauryl-thiopropionate). These may be used singly or in combination.

The sulfur-based rubber antioxidant may be an imidazole-based rubber antioxidant. The imidazole-based rubber antioxidant may be 2-mercaptobenzimidazole, a zinc salt of 2-mercaptobenzimidazole, 2-mercaptomethylbenzimidazole, a zinc salt of 2-mercaptomethylbenzimidazole, or any combination thereof.

(Molded Article)

A molded article according to an embodiment is obtained by molding the rubber composition according to the embodiment described above into a predetermined shape. The molded article is typically a vulcanized rubber composition. The method of producing the molded article according to the present embodiment from the rubber composition can include molding the rubber composition to form a molded article and vulcanizing the rubber composition. The rubber composition may be vulcanized while being formed into a molded article, or the rubber composition may be formed into a molded article and then the rubber composition forming the molded article may be vulcanized.

The rubber composition can be obtained, for example, by kneading a mixture containing the ethylene-α-olefin-nonconjugated polyene copolymer rubber, the phenolic antioxidant, and other components to be added if necessary. Kneading can be conducted by using an internal mixing machine such as a mixer, a kneader, or a twin screw extruder. The kneading time is, for example, from 1 to 60 minutes. The kneading temperature is, for example, from 40° C. to 200° C.

The vulcanizable rubber composition obtained in the kneading step is molded, for example, by using a molding machine such as an injection molding machine, a compression molding machine, or a hot air vulcanizing apparatus. The heating temperature for molding may be from 120° C. to 250° C. or from 140° C. to 220° C. The time required for molding is, for example, from 1 to 60 minutes. A molded article vulcanized can be obtained by vulcanizing the rubber composition through heating at the time of molding.

Various kinds of products such as hoses, belts, automobile parts, building materials, and vibration damping rubber can be produced by a usual method using the molded article obtained by such a method.

### EXAMPLE

Hereinafter, the present invention will be more specifically described with reference to Examples. However, the present invention is not limited to the following Examples.

1. Synthesis of ethylene-α-olefin-nonconjugated Polyene Copolymer Rubber

(EPDM-1)

Into a first polymerization tank which was made of stainless steel and equipped with a stirrer, hexane was supplied at a velocity of 125.8 g/(hr L), ethylene at a velocity of 5.6 g/(hr L), and propylene at a velocity of 1.7 g/(hr L) per unit time and unit volume of the polymerization tank. Into the first polymerization tank, VOCl₃ was supplied at a velocity of 92.8 mg/(hr L), ethylaluminum sesquichloride (EASC) at a velocity of 230.7 mg/(hr L), and hydrogen at a velocity of 0.12 NL/(hr L). Into the first polymerization tank, 5-ethylidene-2-norbornene was further supplied at a velocity of 0.3 g/(hr L). The temperature of the first polymerization tank was kept at 50° C. In the first polymerization tank, ethylene-propylene-5-ethylidene-2-norbornene copolymer rubber was produced at 7.6 g/(hr L) per unit time and unit volume of the polymerization tank. The copolymer rubber recovered from the polymerization solution was dried to obtain a solid copolymer rubber (EPDM-1).

(EPDM-2)

EPDM-2 was synthesized in the same manner as in Example 1 except that the kinds and amounts of the respective components supplied were changed as described in Table 1.

(EPDM-3)

EPDM-3 was synthesized in the same manner as in Example 1 except that the kinds and amounts of the respective components supplied were changed as described in Table 1, the reaction was conducted after the polymerization solution in the first polymerization tank had been transferred to the second polymerization tank, and the polymerization solution was recovered to obtain a copolymer rubber.

TABLE 1

| EPDM | | 1 | 2 | 3 |
|---|---|---|---|---|
| First polymerization tank | | | | |
| Hexane | g/hr · L | 125.8 | 125.8 | 585.6 |
| Propylene | g/hr · L | 1.7 | 1.9 | 12.6 |
| Ethylene | g/hr · L | 5.6 | 5.4 | 29.3 |
| VOCl₃ | mg/hr · L | 92.8 | 74.3 | 58.5 |
| EASC | mg/hr · L | 230.7 | 184.6 | 292.6 |
| Ethanol | mg/hr · L | — | 2.14 | — |
| Hydrogen | NL/hr · L | 0.12 | 0.108 | 0.056 |
| 5-Ethylidene-2-norbornene | g/hr · L | 0.3 | 0.3 | 2.3 |
| Polymerization temperature | ° C. | 53 | 53 | 54 |
| Second polymerization tank | | | | |
| Hexane | g/hr · L | — | — | 243.5 |
| Propylene | g/hr · L | — | — | 6.3 |
| Ethylene | g/hr · L | — | — | 14.6 |
| VOCl₃ | mg/hr · L | — | — | 39.3 |
| EASC | mg/hr · L | — | — | 78.6 |
| Hydrogen | NL/hr · L | — | — | 1.14 |
| 5-Ethylidene-2-norbornene | g/hr · L | — | — | 243.5 |
| Polymerization temperature | ° C. | — | — | 59 |
| Produced amount | g/hr · L | 7.6 | 7.6 | 66 |

2. Preparation of Rubber Composition

### Example 1

By using a Banbury mixer (manufactured by Kobe Steel, Ltd.) adjusted to 200° C., 100 parts by mass of EPDM-1, and 0.24 part by mass of a phenolic antioxidant (Irganox 1076 manufactured by BASF SE), and 0.03 part by mass of a phosphorus-based antioxidant (Irgafos 168 manufactured by BASF SE) were kneaded for 10 minutes at a rotor rotating speed of 60 rpm to obtain a rubber.

### Examples 2

A rubber composition was obtained in the same manner as in Example 1 except that the amount of Irganox 1076 was changed to 0.12 part by mass.

### Comparative Example 1

A rubber composition was obtained in the same manner as in Example 1 except that 100 parts by mass of EPDM-2, 0.24 part by mass of Irganox 1076, and 0.12 part by mass of a phenolic antioxidant (SUMILIZER (registered trademark) GM, manufactured by SUMITOMO CHEMICAL CO., LTD.) were used.

### Comparative Examples 2 to 6

Rubber compositions were obtained in the same manner as in Example 1 except that 100 parts by mass of EPDM-3 and the antioxidants presented in Table 4 were used.

3. Evaluation

The copolymer rubbers and the rubber compositions were evaluated as follows. The results are presented in Tables 3 and 4.

(1) Intrinsic Viscosity [η]

The reduced viscosity (viscosity number) of a copolymer solution of which the concentration was known was measured in tetralin at 135° C. by using an Ubbelohde viscometer. The intrinsic viscosity of the copolymer rubber was determined from the measurement results according to the calculation method described in “Koubunshi Youeki, Koubunshi Zikkengaku 11 (Polymer Solutions and Polymer Experiments 11)” (1982, published by Kyoritsu Shuppan Co., Ltd.), page 491.

(2) Content of Ethylene Unit

The copolymer rubber was molded to produce a film having a thickness of about 0.1 mm by using a hot press machine. The infrared absorption spectrum of this film was measured by using an infrared spectrophotometer (IR-810 manufactured by JASCO Corporation). The content of ethylene unit with respect to the total amount of the ethylene unit, the α-olefin unit, and the nonconjugated polyene unit were determined from the infrared absorption spectrum obtained according to the method described in the reference literatures (“Characterization of polyethylene by infrared absorption spectrum by Takayama”, Usami et al. or Die Makromolekulare Chemie, 177, 461 (1976) by Mc Rae, M. A., Maddam S, W. F. et al.).

(3) Proportion of Cyclohexane Insoluble Component

A portion having a thickness of 1 mm was cut off from the side face of the solid copolymer rubber by using scissors. The small pieces cut were further cut to obtain a substantially cubic sample of 1 mm square. The mass (A) of about 0.5 g of the sample obtained was precisely weighed by using an electronic balance. Subsequently, the sample was placed in an Erlenmeyer flask with a stopper having a volume of 500 mL. Thereinto, 250 mL of cyclohexane was weighed by using a measuring cylinder and poured to immerse the sample in the cyclohexane. In the cyclohexane, 6-bis(tert-butyl)-4-methylphenol (SUMILIZER (registered trademark) BHT) having a concentration of 0.1% by mass had been dissolved in advance. The Erlenmeyer flask was left to stand in a constant temperature water bath at 25° C. for 24 hours. The Erlenmeyer flask taken out from the constant temperature water bath was stoppered and then shaken for 1 hour by using a shaker. The shaking speed was set to 120 rpm.

The mass (B) of a 120-mesh wire gauze was precisely weighed by using an electronic balance. The solution in the flask was filtered through this wire gauze. At the time of filtration, the residue in the Erlenmeyer flask was washed toward the wire gauze with about 20 mL of new cyclohexane. The wire gauze after filtration was dried on a hot plate at from 60° C. to 90° C. for 3 hours together with the filtered solid components on the wire gauze. The wire gauze after drying was cooled to room temperature in a desiccator over about 30 minutes. The mass (C) of the wire gauze after cooling was precisely weighed by using an electronic balance.

The proportion (% by mass) of the cyclohexane insoluble component was calculated by substituting the mass A of the sample before being immersed in cyclohexane, the mass B (tare) of the wire gauze, and the mass C of the wire gauze after filtration and drying into the following equation.

Proportion of cyclohexane insoluble component={(C—B)/A}×100

(4) Glass Transition Temperature (Tg)

The differential scanning calorie (DSC) of the copolymer rubber was measured at a rate of temperature increase of 5° C./min. The temperature at the midpoint of the glass transition portion in the DSC thermogram obtained was taken as the glass transition temperature.

(5) Molecular Weight Distribution (Mw/Mn)

The values of weight average molecular weight (Mw) and number average molecular weight (Mn) of the copolymer rubber in terms of standard polystyrene were measured by gel permeation chromatography (GPC) under the following conditions. The molecular weight distribution (Mw/Mn) was calculated from the Mw and Mn obtained.
GPC apparatus: HLC-8121 GPC/HT (trade name) manufactured by Tosoh Corporation
Column: TSKgel GMHHR-H(S) HT (trade name) manufactured by Tosoh Corporation
Standard substance for molecular weight: polystyrene having molecular weight of 500 or more and 20,000,000 or less
Flow rate of eluting solvent: 1.0 mL/min
Concentration of sample: 1 mg/mL
Measured temperature: 140° C.
Eluting solvent: orthodichlorobenzene
Injection volume: 500 μL
Detector: differential refractometer

(6) Measurement of Yellow Index

The rubber composition was molded into a thickness of 4 mm to produce a sample for measurement of yellow index. The yellow index (YI value) of the sample was measured by using a spectrophotometer SC-T45 manufactured by Suga Test Instruments Co., Ltd. in conformity to JIS K7373: 2006. Background measurement was conducted in the absence of sample, then the sample was set in the sample holder, the transmittance thereof with respect to light at from 300 to 800 nm was measured, and the tristimulus values (X, Y, Z) were determined. The YI value was calculated based on the following equation.

YI=100×(1.2769X−1.0592Z)/Y

(7) Method of Evaluating Mutual Adhesive Property

In a paper tube having an inner diameter of 76.5 mm and a height of 120 mm, 100 g of the rubber composition was placed, a weight of 1 kg was placed on the surface of the rubber composition, and then the paper tube was stored in a constant temperature and constant humidity bath at a temperature of 35° C. and a humidity of 50% for 24 hours. After the storage, the mutual adhesive property of the rubber composition was evaluated according to the criteria presented in Table 2.

TABLE 2

| Points | First measurement | Second measurement |
|---|---|---|
| 10 | Rubber composition comes out when | Rubber composition does not stick. |
| 9 | outer cylinder is only lifted. | Rubber composition lightly sticks. |
| 8 | Rubber composition comes out when | Rubber composition does not stick. |
| 7 | central portion is lightly pushed. | Rubber composition lightly sticks. |
| 6 | Rubber composition comes out and | Rubber composition lightly sticks. |
| 5 | forms a domed shape when central | There is block-shaped small lump. |
| 4 | portion is strongly pushed. | There is block-shaped large lump. |
| 3 | Rubber composition comes out but | Rubber composition collapses by being |
| | maintains cylindrical shape when | lightly pushed. |
| 2 | central portion is strongly pushed. | Rubber composition collapses by being |
| | | strongly pushed. |
| 1 | | Rubber composition is close to bale shape. |

TABLE 3

| | Example 1 | Example 2 |
|---|---|---|
| EPDM | 1 | 1 |
| [η] (dL/g) | 1.2 | 1.2 |
| Ethylene unit (% by mass) | 73.5 | 73.5 |
| Cyclohexane insoluble | 14.2 | 14.2 |
| component (% by mass) | | |
| Tg (° C.) | −44 | −44 |
| Mw/Mn | 2.2 | 2.2 |
| Irganox 1076 (parts by mass) | 0.24 | 0.12 |
| Irgafos 168 (parts by mass) | 0.03 | 0.03 |
| YI | 2.9 | −22.9 |
| Mutual adhesive property | 8 | 8 |

TABLE 4

| Comparative Example | 1 | 2 | 3 | 4 | 5 | 6 |
|---|---|---|---|---|---|---|
| EPDM | 2 | 3 | 3 | 3 | 3 | 3 |
| [η] (dL/g) | 1.2 | 2.1 | 2.1 | 2.1 | 2.1 | 2.1 |
| Ethylene unit (% by mass) | 70 | 65 | 65 | 65 | 65 | 65 |
| Cyclohexane insoluble | 0.2 | 15.0 | 15.0 | 15.0 | 15.0 | 15.0 |
| component (% by mass) | | | | | | |
| Tg (° C.) | −45 | −48 | −48 | −48 | −48 | −48 |
| Mw/Mn | 1.8 | 2.2 | 2.2 | 2.2 | 2.2 | 2.2 |
| Irganox 1076 (parts by mass) | 0.24 | 0.12 | 0.12 | 0.06 | 0.12 | 0.12 |
| SUMILIZER GM (parts by mass) | 0.12 | — | — | — | 0.06 | 0.04 |
| Irgafos 168 (parts by mass) | — | — | 0.06 | — | — | — |
| YI | 48.2 | −7.1 | −15.9 | −14.6 | 1.46 | −4.8 |
| Mutual adhesive property | 4 | 1 | 1 | 1 | 1 | 1 |

1. A rubber composition comprising an ethylene-α-olefin-nonconjugated polyene copolymer rubber and a phenolic antioxidant, wherein
a content of an ethylene unit in the ethylene-α-olefin-nonconjugated polyene copolymer rubber is from 71% to 99% by mass with respect to a total amount of the ethylene unit, an α-olefin unit, and a nonconjugated polyene unit,
a proportion of a cyclohexane insoluble component in the ethylene-α-olefin-nonconjugated polyene copolymer rubber at 25° C. is from 0.2% to 50% by mass with respect to a mass of the ethylene-α-olefin-nonconjugated polyene copolymer rubber, and
a content of the phenolic antioxidant is from 0.01 to 0.35 part by mass with respect to 100 parts by mass of a content of the ethylene-α-olefin-nonconjugated polyene copolymer rubber.

2. The rubber composition according to claim 1, further comprising a phosphorus-based antioxidant, wherein
a content of the phosphorus-based antioxidant is 0.20 part by mass or less with respect to 100 parts by mass of a content of the ethylene-α-olefin-nonconjugated polyene copolymer rubber.

3. The rubber composition according to claim 1, wherein an intrinsic viscosity of the ethylene-α-olefin-nonconjugated polyene copolymer rubber measured in tetralin at 135° C. is from 0.5 to 5.0 dL/g.

4. The rubber composition according to claim 1, wherein a glass transition temperature of the ethylene-α-olefin-nonconjugated polyene copolymer rubber is from −55° C. to −30° C.

5. The rubber composition according to claim 2, wherein an intrinsic viscosity of the ethylene-α-olefin-nonconjugated polyene copolymer rubber measured in tetralin at 135° C. is from 0.5 to 5.0 dL/g.

6. The rubber composition according to claim 2, wherein a glass transition temperature of the ethylene-α-olefin-nonconjugated polyene copolymer rubber is from −55° C. to −30° C.

7. The rubber composition according to claim 3, wherein a glass transition temperature of the ethylene-α-olefin-nonconjugated polyene copolymer rubber is from −55° C. to −30° C.

8. The rubber composition according to claim 5, wherein a glass transition temperature of the ethylene-α-olefin-nonconjugated polyene copolymer rubber is from −55° C. to −30° C.
